(19) United States
(12) Patent Application Publication
(10) Pub. No.: US 2013/0265430 A1
(43) Pub. Date: Oct. 10, 2013

(54) IMAGE CAPTURING APPARATUS AND ITS METHOD FOR ADJUSTING A FIELD IN WHICH TO CAPTURE AN IMAGE

(71) Applicants: INVENTEC APPLIANCES (PUDONG) CORPORATION, (US); INVENTEC APPLIANCES CORP., New Taipei City (TW); INVENTEC APPLIANCES (SHANGHAI) CO. LTD., Shanghai City (CN)

(72) Inventor: Chia-Yao Chang, New Taipei City (TW)

(73) Assignees: INVENTEC APPLIANCES (PUDONG) CORPORATION, Shanghai (CN); INVENTEC APPLIANCES (SHANGHAI) CO. LTD., Shanghai City (CN); INVENTEC APPLIANCES CORP., New Taipei City (TW)

(21) Appl. No.: 13/846,167

(22) Filed: Mar. 18, 2013

(30) Foreign Application Priority Data
Apr. 6, 2012 (CN) 201210099637.1

(51) Int. Cl. H04N 5/225

(52) U.S. Cl. CPC H04N 5/2251
USPC 348/148

(57) ABSTRACT

An image capturing apparatus and a method for adjusting a field in which to capture an image are provided for use with a vehicle. The apparatus comprises a support structure, an image capturing body, and a reacting element. The support structure includes a securing base to be secured to the vehicle, a connecting part connected to the image capturing body, and an orientation adjustment structure adjustable to change an orientation of the connecting part relative to the securing base. The image capturing body includes a processing unit configured to generate an event signal upon judging that the image does not conform with a predefined condition. And the reacting element is disposed on the support structure or the image capturing body and is configured to receive the event signal or be activated by the event signal.

### CROSS-REFERENCE TO RELATED APPLICATIONS

This non-provisional application claims priority under 35 U.S.C. §119(a) on Patent Application No(s). 201210099637.1 filed in China, P.R.C. on Apr. 6, 2012, the entire contents of which are hereby incorporated by reference.

1. Field of the Invention

The present invention relates to an image capturing apparatus and its method for adjusting a field in which to capture an image, and more particularly relates to an image capturing apparatus and a method which can be used or implemented to examine an image captured by the image capturing apparatus and perform an adjustment when the image is judged to be of something outside a predetermined field in which to capture the image.

2. Background of the Invention

Attending with the rapidly progressive of transportation industry, private vehicles become more and more popular, which accompanies the increasing number of vehicles on the road and the traffic also becomes more and more complicated. As a result, the rate of various traffic accidents is also increasing. To enhance traffic safety and clarify responsibility belonging when the traffic accident happens, many users assemble the image capturing apparatus, such as an event data recorder (EDR), in their vehicles to record the surrounding image information for the purposes of surveillance or accident cause analysis with the help of related accident reconstruction technologies.

The conventional image capturing apparatus as mentioned above are secured to the vehicles by suctioning, sticking, or clamping. However, such securing methods have the following serious drawback. As the camera of the image capturing apparatus captures the image, from which image information is obtained, in its field of view, the camera lens must have a predefined field, expected by the user, in which to capture the image for correctly recording the image the user intended to capture as image information, thereby making the most of the image capturing apparatus. However, because shaking or vibration of the (moving) vehicle is unpreventable and the user might inadvertently touch the image capturing apparatus, it is very difficult to prevent the image capturing apparatus from shifting from a predefined orientation from which the camera lens has the predefined field, even after the image capturing apparatus is carefully adjusted to having the right orientation to cause the camera lens thereof to have the wanted field of view in which to capture the image. At this time, if the user cannot be aware in time that the image capturing apparatus has shifted from a predefined orientation, the image information within the predefined field in which to capture the image will not be correctly obtained to achieve the purposes of surveillance and an accident's cause determination which rely on the correct image information in the predefined field in which to capture the image.

Accordingly, there is a need to design a method to adjust the field in which to capture the image, by which method to adjust an orientation of the image capturing apparatus upon determining that the image information is of something outside the predefined field in which to capture the image, so as to ensure the image capturing apparatus correctly record the image information (of something) within the predefined field in which to capture the image.

### BRIEF SUMMARY OF INVENTION

Given that the conventional image capturing apparatus when used with a vehicle is easily affected by shaking or vibration of the (moving) vehicle or is easily inadvertently touched by passengers or users of the vehicle, so the image (information) captured by the image capturing apparatus might be (of something) outside the predefined field in which to capture the image, easily due to shaking of the vehicle and inadvertently touching the vehicle. Thus, the function of the image capturing apparatus would be seriously affected. Accordingly, the inventor(s) has developed an image capturing apparatus and its method for adjusting a field in which to capture an image as the present invention to resolve the drawbacks described of the prior art and to greatly enhance the utility value of the image capturing apparatus.

It is an object of the present invention to provide an image capturing apparatus for use with a vehicle. The image capturing apparatus includes a support structure, an image capturing body, and a reacting element. The support structure includes a securing base, a connecting part, and an orientation adjustment structure. The securing base is to be secured to the vehicle, the orientation adjustment structure is disposed between the base and the connecting part and is adjustable to change an orientation of the connecting part relative to the securing base. The image capturing body is connected to the connecting part and includes an image capturing unit, a processing unit, and a storage unit. The image capturing unit is configured to capture an image for obtaining image information thereof. The processing unit is electrically connected to the storage unit and the image capturing unit and is configured to access the image information or stored information in the storage unit. And the processing unit is configured to generate an event signal upon judging that the image does not conform with a predefined condition. The reacting element is disposed on the support structure or the image capturing body, and is configured to receive the event signal or be activated by the event signal.

In some embodiments the processing unit is configured to perform a graphics examining program to examine the image information for judging if the image information includes identification mark information or coordinate information specified by the predefined condition. This can help the processing unit judge if the image captured by the image capturing body is of something outside the predefined field in which to capture the image. In some embodiments, when the orientation of the image capturing body relative to the securing base has changed due to vibration of the vehicle or inadvertent touching the vehicle by the user, causing the image capturing apparatus to not have the predefined field, an actuator of the reacting element may be activated by the event signal so as to actuate the orientation adjustment structure until the image conforms with the predefined condition, for achieving an object of performing adjustment of the field in which to capture the image through the image capturing body.

The present invention also provides a method for adjusting a field in which to capture an image, applicable to an image capturing apparatus including a support structure, an image capturing body, and a reacting element. The support structure is connected to the image capturing body and to be secured to a vehicle. The image capturing body includes an image capturing unit and a storage unit. The image capturing unit is configured to capture an image for obtaining image information thereof, and the reacting element is disposed on the support structure or the image capturing body. And the method includes comparing the image information and stored information in the storage unit; generating an event signal upon judging that the image does not conform with a predefined condition; and activating the reacting element by the event signal, for adjusting a field in which to capture the image.

The embodiments of the present invention will be further discussed using the following paragraphs and the figures for a better understanding.

### BRIEF DESCRIPTION OF THE DRAWINGS

FIG. 1 is a schematic view showing the hardware of the image capturing apparatus according to a preferred embodiment of the present invention;

FIG. 2 is a schematic view showing the units within the image capturing body according to a preferred embodiment of the present invention;

FIG. 3A is a schematic view showing the image information captured by the image capturing body which is having the predefined field in which to capture the image;

FIG. 3B is a schematic view showing the image information captured by the image capturing body which has shifted and thus is not having the predefined field in which to capture the image; and

FIG. 4 is a flowchart showing the method for adjusting the field in which to capture the image according to a preferred embodiment of the present invention.

### DETAILED DESCRIPTION OF THE INVENTION

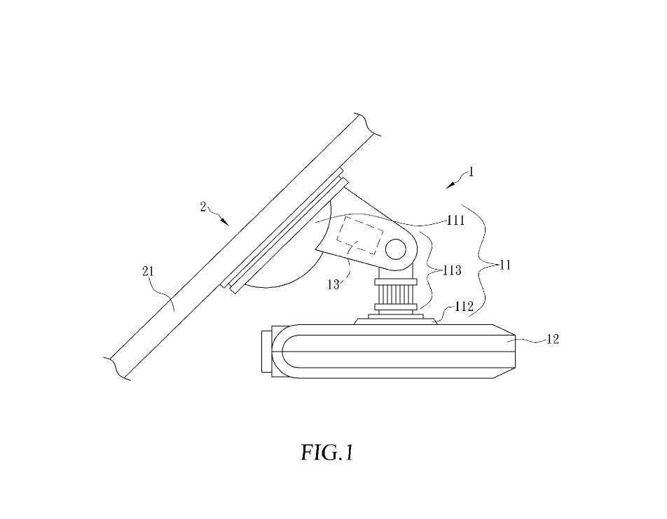

The present invention is related to an image capturing apparatus and a method for adjusting a field in which to capture an image thereof. As shown in FIG. 1, in accordance with a preferred embodiment of the present invention, the image capturing apparatus 1 is applicable to a vehicle 2 and includes a support structure 11, an image capturing body 12, and a reacting element 13, such as a speaker, a lighting element, or a step motor. The support structure 11 includes a securing base 111, a connecting part 112, and an orientation adjustment structure 113. The securing base 111 is disposed at an end of the support structure 11. In the present embodiment, the securing base 111 is stuck on the wind shield glass 21 to cause the image capturing apparatus 1 as a whole to be fixed on the vehicle 2 thereby. However, the present invention is not so restricted, in accordance with other preferred embodiment of the present invention, a suction cup (not shown) or a clamper (not shown) may be attached to the securing base 111 to have the securing base 111 secured to the wind shield glass 21 by suction or to a side mirror (not shown) by clamping. It is understood that various ways for securing the securing base 111 to the vehicle 2 can be modified according to the need.

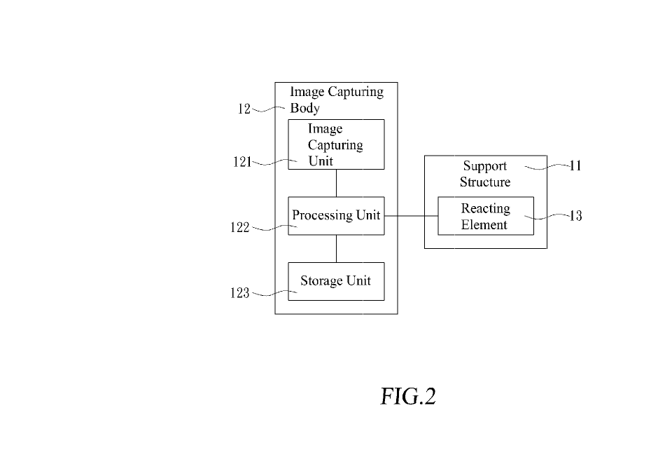

The connecting part 112 is disposed at the other end of the support structure 11 for connecting the image capturing body 12. The orientation adjustment structure 113 is disposed between the securing base 111 and the connecting part 112 and is adjustable to change an orientation of the connecting part 112 relative to the securing base 111. It's noted that the orientation of the connecting part 112 relative to the securing base 111 may include for example an angle between the connecting part 112 and the securing base 111. Also referring to FIG. 2, the image capturing body 12 includes an image capturing unit 121, a processing unit 122, and a storage unit 123. The image capturing unit 121 is configured to capture an image and converting the captured image into image information. The processing unit 122 is electrically connected to the storage unit 123 and the image capturing unit 121 and is configured to receive the image information and access various kinds of information in the storage unit 123. In addition, the processing unit 122 is also configured to perform a graphics examining program to examine the image information.

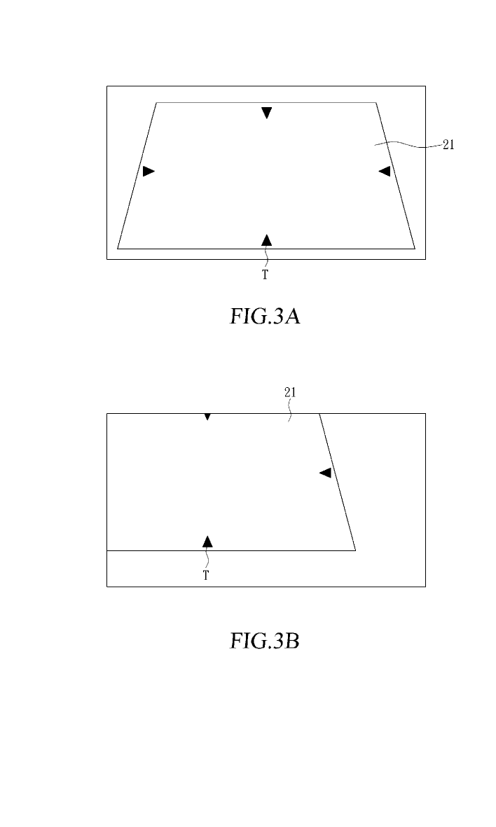

Also referring to FIG. 3A, in the present preferred embodiment, to facilitate performing the graphics examining program to examine the image information captured by the image capturing body 12 (as shown in FIG. 2), four identification marks T are stuck on the wind shield glass 21 and each of the identification mark T is located at the middle near the respective edge of the wind shield glass 21 such that when an image is captured in a predefined field by the image capturing body 21, the graphics of identification marks T at the middle near the four edges would be captured such that the graphic information, such as shape, pattern, or color, of the identification marks T as well as the relative coordinate of the identification marks T with respective to the image would be recorded in the image information. Then, the graphics examining program is capable of examining the image according to a predefined condition stored in the storage unit 123 (as shown in FIG. 2). The predefined condition includes identification information and coordinate information. The graphics examining program may judge if the image includes at least a graphic matches the identification information. In the present embodiment, the graphic information of the identification mark T is set as the identification information such that the graphics examining program is capable of figuring out the graphics matching the identification information and further accessing the relative coordinate of these graphics with respective to the image to determined if the graphics are located within a predefined field defined by the coordinate information. That is, the graphics examining program is capable to judge if the image fulfills the predefined condition through the analysis of the image information by using the identification information and the coordinate information. To be noted, in order to enhance recognizable of these identification marks T in the image to have the graphics examining program judges the situation of the identification marks T in the image correctly, according to other preferred embodiments of the present invention, the identification mark T may be fabricated by luminescence materials such that the graphic examining program can judge the situation of the identification marks T in the image correctly even when the user drives the vehicle 2 at light, in the tunnel, or under other poor lighting conditions.

As mentioned above, if the user of the vehicle 2 touches the image capturing body 12 inadvertently or the image capturing body 12 has shifted due to vibration of the (moving) vehicle 2, the image captured by the image capturing body 12 would be of something outside the predefined field in which to capture the image. Also referring to FIG. 3B, if the outside image only has the complete graphics of the identification marks T near the right side and the lower side, but loses the graphic of the identification mark T near the left side and has an incomplete graphic near the upper side, the graphics examining program may analyze the graphic information of the identification marks T within the image information by using the identification information and the coordinate information to determine that the image capturing body 12 (as shown in FIG. 2) has shifted and thus is not having its predefined field in which to capture an image, after comparing the actual coordinates of the identification marks T and the predefined coordinates of the identification marks T. Then, the graphics examining program will trigger the processing unit 122 (as shown in FIG. 2) to generate an event signal upon the judging result.

It is also noted that, in the present preferred embodiment, the identification marks T are stuck on the wind shield glass 21, and “all the graphics of the identification marks T being completely shown at the middle near the four edges of the image” is given as the predefined condition and the graphics examining program judges if the image information conforms with the predefined condition, to determine if the orientation of the image capturing body 12 has shifted. However, the present invention is not so restricted. The predefined condition can be defined by different ways. For example, these identification marks T may be stuck on the engine hood of the vehicle 2, the location of the identification marks within the image is redefined and the predefined condition of modified according to the redefined location of the identification marks T. The identification marks T may be further skipped by using the method mentioned below to determine another predefined condition. Firstly, after the user adjusts the image capturing apparatus 1 to a predefined orientation, the image capturing unit 121 is utilized to obtain image information from the image within the predefined field in which to capture the image, as material for comparison. Then, the user may select a configurable graphic in the image, such as the car emblem, store the graphic as identification information, and define a predefined area within a certain distance from the graphic to modify the predefined condition as “the graphic within the predefined area thereof”. Therefore, the graphics examining program only needs to judge if there has the complete graphic in the certain area to determine whether the image capturing apparatus 1 has shifted. In addition, the image capturing apparatus 1 should not be restricted on the front wind shield glass of the vehicle. The image capturing apparatus 1 may be assembled to various locations, such as the rear wind shield glass, the car roof, or the side mirror. The accompanying predefined condition also has many possible variations, which are not repeated here, those skilled in the art should appreciate that they can readily use the disclosed conception and specific embodiments as a basis for designing or modifying other structures for carrying out the same purposes of the present invention without departing from the scope of the present invention.

Referring to FIG. 2, the reacting element 13 is electrically connected to the processing unit 122 to receive the event signal and is further activated by the event signal. In the present embodiment, the reacting element 13 is disposed in the support structure 11 and also includes an actuator, such as a step motor. When the reacting elements is activated, the orientation adjustment structure 113 is driven and co-operated to adjust the orientation of the image capturing body 12 with respect to the support structure 11 so as to change the field in which to capture the image through the image capturing body 12. In the present embodiment, the graphic examining program judges the actual field in which to capture the image has shifted toward the right lower side of the predefined field in which to capture the image according to the identification marks T included in another image as shown in FIG. 3B. Then the graphics examining program generates adjustment information according to the judging result and writes the adjustment information into the event signal such that as the processing unit 122 generates the event signal to drive the reacting element 13, the reacting element 13 may drive the orientation adjustment structure 113 according to the content of the adjusting information and adjust the orientation of the image capturing body 12 with respect to the support structure 11 by using the orientation adjustment structure 113 to cause the field in which to capture the image of the image capturing body 12 to move toward the left upper side. However, the present invention is not so restricted. According to other embodiments of the present invention, the reacting element 13 may be an indicating element, such as a speaker or a lighting element, to produce an indicating signal when receiving the event signal. The indicating signal may be an alarm, a warning light, or other events for drawing attention. The indicating signal can be utilized to have the user notice that the image capturing apparatus has shifted from its predefined orientation and the user needs to adjust the field in which to capture the image through the image capturing body 12 manually to achieve the object of complementarily adjusting the field in which to capture the image. Therefore, the reacting element 13 is not restricted to being disposed on the support structure 11. The reacting element 13 may alternatively be disposed on the image capturing body 12. As a result, because the processing unit 122 is capable of judging if the image captured by the image capturing body 12 is of something outside the predefined field in which to capture the image, by using the graphics examining program, the reacting element 13 may be adaptively activated by the event signal when the orientation of the image capturing body 12 with respect to the securing base 111 changes due to vibration of the vehicle 2 or inadvertent touching the vehicle 2 by the user, so as to achieve the object of performing adjustment of the field in which to capture the image through the image capturing body 12.

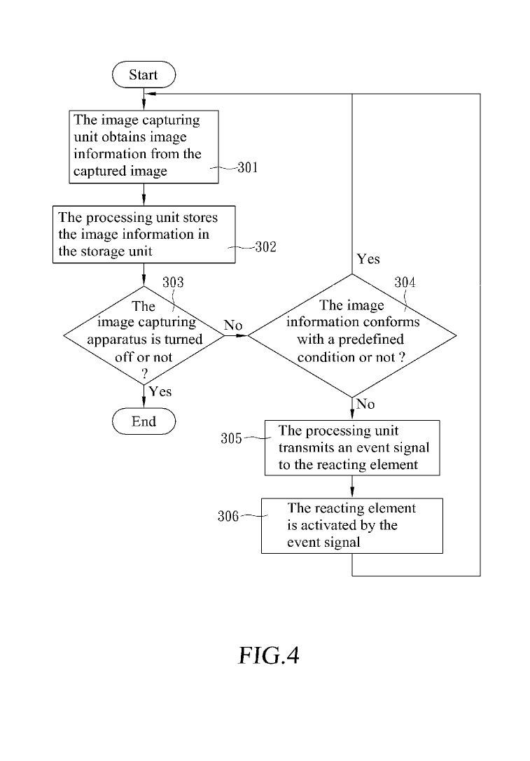

In conclusion, to further clarify the technology disclosed in the present invention, a flow chart is shown in FIG. 4 to describe the main operating steps according to a preferred embodiment of the present invention.

At step 301, the image capturing unit obtains image information from the captured image.

At step 302, the processing unit receives the image information from the image capturing unit and stores the image information in the storage unit. In other embodiments, the image information may not be stored into the storage unit.

At step 303, the processing unit judges if the image capturing apparatus is turned off. If so, the process ends; if not, the process proceeds to step 304. In other embodiments, the processing unit may judge if the image capturing apparatus is deactivated or not.

At step 304, the processing unit judges if the image (information) conforms with a predefined condition. If so, in a preferred embodiment, the process returns to step 301; if not, the process proceeds to step 305.

At step 305, the processing unit transmits an event signal to the reacting element.

At step 306, the reacting element receives the event signal or is activated by the event signal. Then, in a preferred embodiment, the process returns to step 301.

Referring to FIGS. 2 and 4, according to the above mentioned process, after the reacting element 13 is activated by the event signal, the graphics examining program still monitors the following image signals received by the processing unit 122 and judges if the received image information conforms with the predefined condition. If not, the graphics examining program will transmit another event signal to activate the reacting element 13. That is, if the reacting element includes an indicating element and the image capturing body 12 has not been adjusted to a right orientation to cause the image information transmitted from the image capturing unit 121 to the processing unit 122 to conform with the predefined condition, the indicating element of the reacting element 13 will continuously or periodically produce the indicating signal until the image capturing body 12 is adjusted to the right orientation to cause the image information transmitted from the image capturing unit 121 to the processing unit 122 to conform with the predefined condition. If the reacting elements includes an activator, the reacting element 13 will continuously adjust the orientation of the image capturing body according to the adjustment information carried by the event signal until the image information transmitted from the image capturing unit 121 to the processing unit 122 conforms with the predefined condition. It should be noted that the above mentioned process only includes the main operating steps of the present invention, additional settings may be integrated into this process. In accordance with another preferred embodiment of the present invention, to prevent the complicated examining work wastes large amounts of system resource, the processing unit 122 may perform a clock program for periodically performing the graphics examining program to judge if the image information received by the processing unit 122 then conforms with the predefined condition. Because the processing unit 122 does not need to examine all image information by using the graphic examining program, system resource wasted by the processing unit 122 to perform the graphics examining program can be enormously reduced.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. An image capturing apparatus for use with a vehicle, the apparatus comprising:
a support structure, including a securing base, a connecting part, and an orientation adjustment structure, wherein the securing base is to be secured to the vehicle, the orientation adjustment structure is disposed between the base and the connecting part and is adjustable to change an orientation of the connecting part relative to the securing base;
an image capturing body, connected to the connecting part, and including an image capturing unit, a processing unit, and a storage unit, wherein the image capturing unit is configured to capture an image for obtaining image information thereof, the processing unit is electrically connected to the storage unit and the image capturing unit and is configured to access the image information, or stored information in the storage unit, and the processing unit is configured to generate an event signal upon judging that the image does not conform with a predefined condition; and
a reacting element, disposed on the support structure or the image capturing body, and configured to receive the event signal or be activated by the event signal.

2. The image capturing apparatus of claim 1, wherein the processing unit is configured to perform a graphics examining program to examine the image information for judging if the image information includes identification mark information or coordinate information specified by the predefined condition.

3. The image capturing apparatus of claim 2, wherein the processing unit is configured to perform a clock program for periodically performing the graphics examining program.

4. The image capturing apparatus of claim 1, wherein the reacting element has an indicating element to be activated by the event signal to produce an indicating signal.

5. The image capturing apparatus of claim 1, wherein the reacting element has an actuator to be activated by the event signal so as to actuate the orientation adjustment structure until the image conforms with the predefined condition.

6. A method for adjusting a field in which to capture an image, applicable to an image capturing apparatus comprising a support structure, an image capturing body, and a reacting element, wherein the support structure is connected to the image capturing body and to be secured to a vehicle, the image capturing body includes an image capturing unit and a storage unit, the image capturing unit is configured to capture an image for obtaining image information thereof, the reacting element is disposed on the support structure or the image capturing body, and the method comprises the steps of:
comparing the image information and stored information in the storage unit;
generating an event signal upon judging that the image does not conform with a predefined condition; and
activating the reacting element by the event signal, for adjusting a field in which to capture the image.

7. The method of claim 6, wherein the predefined condition specifies identification mark information and coordinate information, and judging if the image conforms with the predefined condition comprises:
performing a graphics examining program to examine the image information to obtain at least an image portion matching the identification mark information;
obtaining a coordinate of the image portion with respect to the image information; and
comparing the coordinate of the image portion and the coordinate information.

8. The method of claim 7, further comprising:
performing a clock program for periodically performing the graphics examining program to examine the image information.

9. The method of claim 6, wherein the reacting element has an indicating element and the step of activating the reacting element by the event signal comprises activating the indicating element by the event signal to produce an indicating signal.

10. The method of claim 6, wherein the support structure includes an orientation adjustment structure adjustable to change an orientation of the support structure, the reacting element has an actuator, and the step of activating the reacting element by the event signal is performed to cause the actuator to actuate the orientation adjustment structure.
